(19) United States
(12) Patent Application Publication
(10) Pub. No.: US 2024/0419335 A1
(43) Pub. Date: Dec. 19, 2024

(54) NAND STORAGE DEVICE

(71) Applicant: DENSO CORPORATION, Kariya-city (JP)

(72) Inventor: Tetsuya KIMATA, Kariya-city (JP)

(21) Appl. No.: 18/742,941

(22) Filed: Jun. 13, 2024

(30) Foreign Application Priority Data
Jun. 15, 2023 (JP) 2023-098601

(51) Int. Cl. G06F 3/06

(52) U.S. Cl. CPC G06F 3/0619; G06F 3/0659; G06F 3/0679

(57) ABSTRACT

A NAND storage device is provided which includes a built-in controller working to compare a bit error in each block of a first memory area of a NAND memory with a first refresh threshold to determine whether data in the first memory area should be self-refreshed. Similarly, the built-in controller also compares a bit error in each block of a second memory area of the NAND memory with a second refresh threshold to determine whether data in the second memory area should be self-refreshed. This structure is capable of setting the refresh thresholds depending on characteristics of data retained in the NAND memory of the NAND storage device.

### CROSS REFERENCE TO RELATED DOCUMENT

The present application claims the benefit of priority of Japanese Patent Application No. 2023-98601 filed on Jun. 15, 2023, the disclosure of which is incorporated in its entirety herein by reference.

### TECHNICAL FIELD

This disclosure relates generally to a NAND storage device.

### BACKGROUND ART

Typical NAND storage devices equipped with a NAND memory have a drawback in that passage of long time since data was written into the NAND memory or repeated reading out of data from the NAND memory may result in bit errors. In order to mitigate such a problem, Japanese Patent First Publication No. 2020-27676 teaches self-refreshing each block of a memory area each time a bit error rate thereof exceeds a threshold value to correct the bit errors.

We have studied the above techniques and found the following disadvantages. Too a low threshold value for the self-refreshing will cause the self-refreshing to be performed more than required, which leads to worse degradation or wear of cells of the NAND memory. Alternatively, too high a threshold for the self-refreshing will cause the power for the NAND storage device to be turned off without refreshing the cells of the NAND storage device for an extended period of time. This may result in no refreshing with the power being kept off for a long period of time (e.g., one year), which leads to a risk that bit errors may be increased undesirably, and thereby data may be lost.

### SUMMARY

It is, therefore, a principal object of this disclosure to provide a NAND storage device which is capable of setting a threshold value for self-refreshing as a function of characteristics of data retained in a NAND memory of the NAND storage device.

According to one aspect of this disclosure, there is provided a NAND storage device is provided which comprises: (a) a NAND memory which is installed in the NAND storage device and includes a first memory area and a second memory area; and (b) a built-in controller which is installed in the NAND storage device and works to write or read data in or from the NAND memory in response to a command outputted from an external device. The built-in controller obtains a first refresh threshold and a second refresh threshold. The built-in controller works to compare a bit error rate in the first memory area of the NAND memory with the first refresh threshold to determine whether data in the first memory area should be self-refreshed and also compare a bit error rate in the second memory area of the NAND memory with the second refresh threshold to determine whether data in the second memory area should be self-refreshed.

In the above structure, a self-refresh threshold value is set which is used to trigger refresh of each memory area in the NAND memory, thereby enabling the self-refresh threshold values to be determined depending upon characteristics of data retained in the memory areas, respectively.

In this disclosure, reference numbers or symbols in brackets represent correspondence relations to elements discussed in embodiments, as described below.

### BRIEF DESCRIPTION OF THE DRAWINGS

The present disclosure will be understood more fully from the detailed description given hereinbelow and from the accompanying drawings of the preferred embodiment of the invention, which, should not be taken to limit the invention to the specific embodiment but are for the purpose of explanation or understanding only.

In the drawings:

FIG. 1 is a block diagram which illustrates an overall structure of a control system according to the first embodiment;

FIG. 2 is a block diagram which illustrates an internal structure of a NAND memory;

FIG. 3 is a flowchart of an error correction program executed by a processor installed in a built-in controller;

FIG. 4 is a flowchart of a refresh program executed by a processor installed in a built-in controller;

FIG. 5 is a sequence diagram which demonstrates operations of a data server, a controller, and a NAND storage device in the second embodiment; and

FIG. 6 is a view which illustrates sizes of data retained in a NAND memory in the third embodiment.

### DESCRIPTION OF THE PREFERRED EMBODIMENTS

### First Embodiment

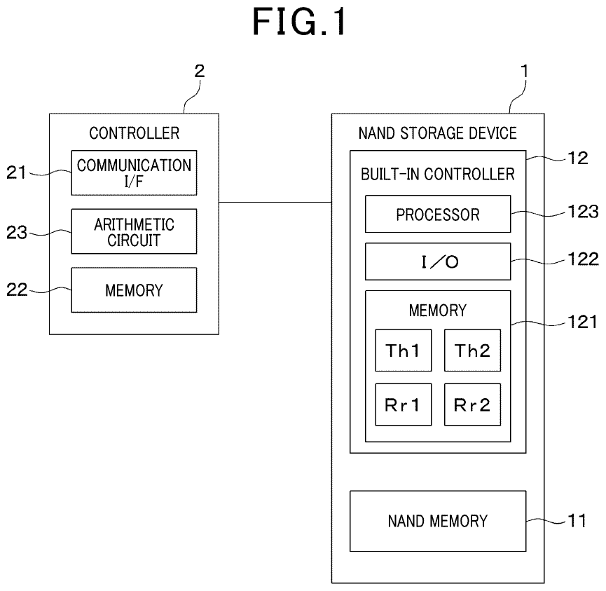

The first embodiment in this disclosure will be described below. A control system in this embodiment, as illustrated in FIG. 1, includes the NAND storage device 1, and the controller 2. The control system is mounted in a vehicle, such as an automobile. The control system may be designed in the form of a single unit or made up of a plurality of discrete parts. The controller 2 serves as an external device arranged outside the NAND storage device 1. The following discussion will refer to an example where the control system is installed in a vehicle and used as a driver-assistance system to assist the driver of the vehicle with a safe operation.

The controller 2 generally includes the communication interface 21, the memory 22, and the arithmetic circuit 23. The communication interface 21 is an interface circuit to establish communication between the controller 2 and devices installed in the vehicle through an in-vehicle LAN (Local Area Network), not shown. For instance, the communication interface 21 communicates with a drive control system for a powertrain of the vehicle, a braking control system to control a braking operation in the vehicle, a steering control system to control a steering operation in the vehicle, and/or a wireless external communication system to communicate with external device(s) arranged outside the vehicle in a wireless mode.

The devices with which the controller 2 communicates through the communication interface 21 also include sensor devices which work to measure a physical behavior of movement of the vehicle, such as the position of the vehicle, the direction in which the vehicle is heading, the speed of the vehicle, the acceleration of the vehicle, and/or the yaw rate of the vehicle, also work to measure surroundings of the vehicle, such as preceding vehicle(s), following vehicle(s), or pedestrian(s), and also work to measure a driver's maneuver, such as a driver's effort on or position of an acceleration pedal of the vehicle, the position of a brake pedal, or a degree to which a steering wheel is turned by the driver of the vehicle.

The memory 22 includes a non-volatile storage and a volatile storage. The non-volatile storage (e.g., a ROM) retains tasks or programs therein which are executed by the arithmetic circuit 23. The volatile storage (e.g., a RAM) serves as a working area used when the arithmetic circuit 23 performs the tasks. Each of the non-volatile storage and the volatile storage functions as a non-transitory tangible storage medium.

The arithmetic circuit 23 reads the program out of the non-volatile storage of the memory 22 or the NAND storage device 1 and executes it. The arithmetic circuit 23 retains in the NAND storage device 1 data derived by the execution of the program as needed. The arithmetic circuit 23 executes the program read out of the NAND storage device 1 to perform a task(s) to assist in driving the vehicle.

The NAND storage device 1 includes the NAND memory 11 and the built-in controller 12. The NAND storage device 1 plays a role as a management NAND device, such as an eMMC (embedded Multi Media Card), a UFS (Universal Flash Storage), a SSD (Solid State Drive).

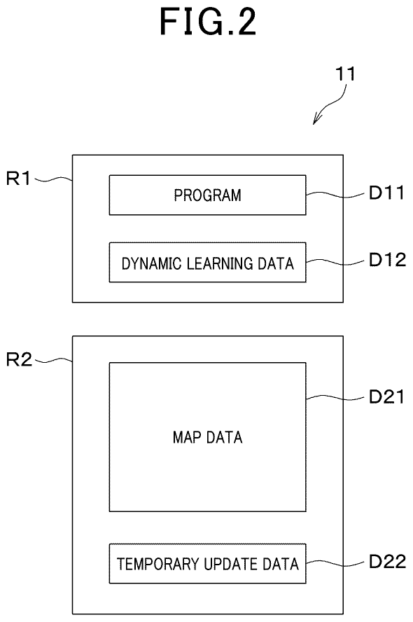

The NAND memory 11 is implemented by a NAND flash memory including a plurality of blocks that are used for data easing in a minimum unit. The NAND memory 11 plays a role as a non-transitory tangible storage medium. The NAND memory 11, as illustrated in FIG. 2, includes a first memory area R1 and a second memory area R2 which are discrete from each other. Each of the first memory area R1 and the second memory area R2 includes the plurality of blocks. The second memory area R2 is greater in data capacity than the first memory area R1.

The first memory area R1 stores the program D11 and the dynamic learning data D12 therein. The program D11 is a program read and executed by the arithmetic circuit 23 of the controller 2. For instance, the program D11 includes a driver-assistance program. The following discussion will refer to an example wherein the program D11 is the driver-assistance program.

The dynamic learning data D12 is looked-up or modified by the controller 2 when the controller 2 executes the program D11. Specifically, during execution of the program D11, the arithmetic circuit 23 derives outputs or sensed parameters constantly or cyclically from the above-described sensor devices through the communication interface 21 and then calculates a variety of operation parameters as a function of the sensed parameters derived from the sensor devices. The arithmetic circuit 23 stores the calculated operation parameters or the sensed parameters derived from the sensor devices in the first memory area R1 in the form of the dynamic learning data D12. The arithmetic circuit 23 then sequentially reads the sensed parameters out of the first memory area R1, performs a learning task using the sensed parameters, and executes the program D11 using operation parameters obtained as a function of results derived by the performing of the learning task. Alternatively, the arithmetic circuit 23 sequentially may read the operation parameters from the first memory area R1 and perform given operations as a function of the operation parameters according to the program D11.

There is a probability that even small corruption of the contents of the program D11 may result in a malfunction of the controller 2. It is, therefore, required to completely avoid any loss of data used in the program D11. For the same reasons as the program D11, the dynamic learning data D12 is required completely to avoid any risk of data loss therefrom. Usually, the dynamic learning data D12 is also subjected to writing of data therein may times or cyclically and, thus, required to completely eliminate a risk of data loss. It is, therefore, advisable that each of the program D11 and the dynamic learning data D12 be refreshed at a decreased time interval.

The second memory area R2 stores the map data D21 and the temporary update data D22 therein. The map data D21 is used when the arithmetic circuit 23 of the controller 2 reads out the program D11 and executes it. The map data D21 includes detailed road information about positions, configurations, the number of lanes, and widths of the lanes which are required for driver's assistance in a self-driving mode of the vehicle.

The temporary update data D22 is data which is derived from an external data server arranged outside the vehicle through the above-described wireless external communication system and used to update the program D11 and the map data D21. The arithmetic circuit 23 constantly or cyclically communicates with the external data server through the communication interface 21 using the wireless external communication system to download the temporary update data D22 therefrom and stores the temporary update data D22 in the second memory area R2 of the NAND storage device 1.

It is not a significant problem if a portion of the map data D21 is lost every passage of a relatively short period of time (e.g., several weeks). This is because it is possible to re-download the map data D21 from the data server if the map data D21 is rendered unable to be read from the NAND memory 11. Similarly, it is not a significant problem if a portion of the temporary update data D22 is lost every passage of a shorter period of time (e.g., a few days). This is because the temporary update data D22 is usually used to update the map data D21 within one day after the temporary update data D22 is downloaded, so that it becomes unnecessary once the map data D21 is updated. Each of the map data D21 and the temporary update data D22 may, therefore, be refreshed at a relatively long time interval (which will also be referred to as a refresh interval). In terms of minimization of wear, the refresh interval of each of the map data D21 and the temporary update data D22 is preferably long.

The built-in controller 12 is a device which is responsive to a command outputted from the controller 2 to write or read data in or from the NAND memory 11. The built-in controller 12, as illustrated in FIG. 1, includes the memory 121, the I/O device 122, and the processor 123.

The memory 121 includes a non-volatile storage and a volatile storage. The non-volatile storage (e.g., a ROM or an EPROM) stores therein programs executed by a processing circuit. The volatile storage (e.g., a RAM) is used as a work area for the processing circuit in performing tasks. The non-volatile storage and the volatile storage are each implemented by a non-transitory tangible storage medium.

The non-volatile storage of the memory 121, as clearly illustrated in FIG. 1, also stores the first refresh threshold Th1 and the second refresh threshold Th2 therein. The first refresh threshold Th1 is a threshold value which is used for comparison with a bit error rate in each block of the first memory area R1, in other words, a reference value used to determine whether the first memory area R1 is required or should be self-refreshed. Similarly, the second refresh threshold Th2 is a threshold value which is used for comparison with a bit error rate in each block of the second memory area R2, in other words, a reference value used to determine whether the second memory area R2 is required or should be self-refreshed. The second refresh threshold Th2 is greater than the first refresh threshold Th1.

The non-volatile storage of the memory 121, as can be seen in FIG. 1, also stores the first range value Rr1 and the second range value Rr2 therein. The first range value Rr1 is a value defining a range of a physical address where the first memory area R1 is located in the NAND memory 11. The second range value Rr2 is a value defining a range of a physical address where the second memory area R2 is located in the NAND memory 11. The second range value Rr2 specifies an address range wider than that specified by the first range value Rr1.

The first refresh threshold Th1, the second refresh threshold Th2, the first range value Rr1, and the second range value Rr2 may alternatively be retained in the NAND memory 11 instead of the memory 121 installed in the built-in controller 12. Alternatively, one or some of the first refresh threshold Th1, the second refresh threshold Th2, the first range value Rr1, and the second range value Rr2 may be stored in the memory 121, while the remainder may be retained in the NAND memory 11.

The I/O device 122 is an interface which works to achieve transmission of data or commands between itself and the controller 2 and also to write or read data in or from the NAND memory 11.

The processor 123 is a circuit which works to read programs from the non-volatile storage of the memory 121 and execute them. The process which reads the programs from the non-volatile storage and executes them includes translation from a logical address to a physical address, management of defective blocks, wear leveling, error correction, and refreshing.

The virtual-to-physical address translation is a process that converts a value of a logical address included in a command received from the controller 2 into a physical address allocated to a memory cell in the NAND memory 11.

Defective block management is to replace a defective block(s) of the NAND memory 11 with another or other blocks (i.e., a spare block(s)). In the block replacement, the logical address allocated to the defective block is re-allocated to the new block. Note that a block becoming defective in the first memory area R1 is replaced with another block in the first memory area R1, while a block becoming defective in the second memory area R2 is replaced with another block in the second memory area R2.

Wear leveling is a technique for re-assigning a logical address of a block of the NAND memory 11 in which the number of times data has been rewritten is greater than a given value to another block in which the number of times data has been rewritten is lesser in order to alleviate an imbalance in number of times data has been rewritten between each block of the NAND memory 11. This wear leveling is performed in the same area of the NAND memory 11. Specifically, the logical address of a block in the first memory area R1 is re-assigned to another block in the first memory area R1. Similarly, the logical address of a block in the second memory area R2 is re-assigned to another block in the second memory area R2.

Operation of the above-described structure of the control system will be described below. When data is required to be read from the NAND storage device 1 during execution of a program, e.g., the program D11 in the arithmetic circuit 23 of the controller 2, the arithmetic circuit 23 outputs a data-reading command to the NAND storage device 1. The data-reading command includes a target logical address space in the NAND memory 11 from which the data is to be read. When the data-reading command is received by the built-in controller 12, the processor 123 reads data from a physical address space in the NAND memory 11 to which the target logical address space corresponds. The processor 123 then transmits the data to the controller 2. This completes the reading of the data made by the controller 2 from the NAND storage device 1.

When data is required to be read from the NAND storage device 1 during execution of a program, e.g., the program D11 in the arithmetic circuit 23, the arithmetic circuit 23 also outputs a data-writing command and data to be written to the NAND storage device 1. The data-writing command includes a target logical address space in the NAND memory 11 in which data should be written. When the built-in controller 12 receives the data-writing command and the data to be written, the processor 123 stores the data in a physical address space in the NAND memory 11 to which the logical address space, as specified by the data-writing command, corresponds. This completes the writing of the data made by the controller 2 in the NAND storage device 1.

The arithmetic circuit 23 executes the program D11 to perform a driver's assistance task. Specifically, the arithmetic circuit 23 analyzes outputs from the above-described sensor devices which measure the physical behavior of movement of the vehicle, the surroundings of the vehicle, and the driver's maneuver and reads the map data D21 from the NAND storage device 1. The arithmetic circuit 23 then calculates a target condition(s) of at least one of driving, braking, and steering of the vehicle using the map data D21 and a control command(s) to a corresponding one(s) of the drive control system, the braking control system, and the steering control system to achieve the target condition.

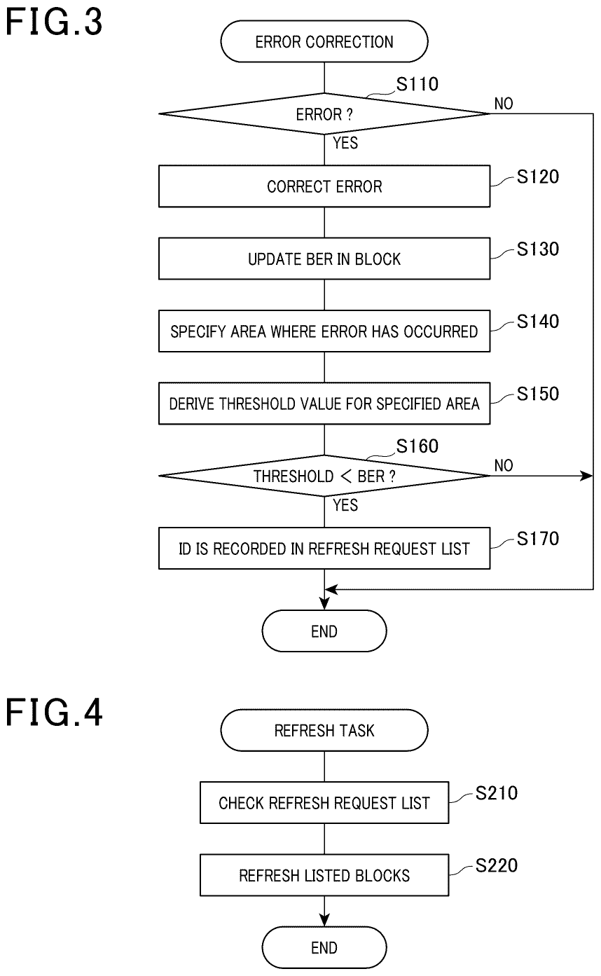

When the control system is operating in the above way, the processor 123 installed in the built-in controller 12 of the NAND storage device 1 works to execute an error correction program, as demonstrated in FIG. 3, in reading data from the NAND memory 11.

After entering the program of FIG. 3 in the processor 123, the routine proceeds to step S110 wherein data read from the NAND memory 11 is subjected to error detection using an ECC (i.e., Error Correction Code) to determine whether an error has occurred in the data in the NAND memory 11. If a NO answer is obtained meaning that no error has occurred in the data, then the routine terminates. Alternatively, if a YES answer is obtained, then the routine proceeds to step S120.

In step S120, the data in the NAND memory 11 in which the error has occurred is corrected. The routine then proceeds to step S130 wherein the error, as determined to have occurred in step S110, is reflected in a bit error rate in a corresponding one of the blocks of the NAND memory 11 to update it. Information about the bit error rate of each block in the NAND memory 11 may be stored in the non-volatile storage of the memory 121 or in the NAND memory 11.

The routine proceeds to step S140 wherein an area in the NAND memory 11 where the error has occurred is specified. Specifically, the first range value Rr1 and the second range value Rr2 are first read from the memory 121. The physical address of the area where the error has occurred, the first range value Rr1, and the second range value Rr2 are used to determine which of the first memory area R1 and the second memory area R2 corresponds to the area where the error has occurred.

The routine proceeds to step S150 wherein a threshold value for self-refreshing of the area specified in step S140 is obtained. Specifically, when the specified area is the first memory area R1, the first refresh threshold Th1 is derived from the memory 121, while when the specified area is the second memory area R2, the second refresh threshold Th2 is derived from the memory 121

The routine proceeds to step S160 wherein one of the first refresh threshold Th1 and the second refresh threshold Th2, as derived in step S150, is compared with the updated bit error rate (BER). If the bit error rate is greater, then the routine proceeds to step S17. Alternatively, if the bit error rate is smaller, then the routine terminates to close the error correction task.

In step S170, an identification number of the block where the error is determined to have occurred in step S110 is recorded in a refresh request list. The refresh request list includes a series of identification numbers (e.g., physical addresses) of the blocks of the NAND memory 11 which are to be refreshed. The refresh request list may be stored in the non-volatile storage of the memory 121 or the NAND memory 11. After step S170, the routine terminates to close the error correction task in this program cycle.

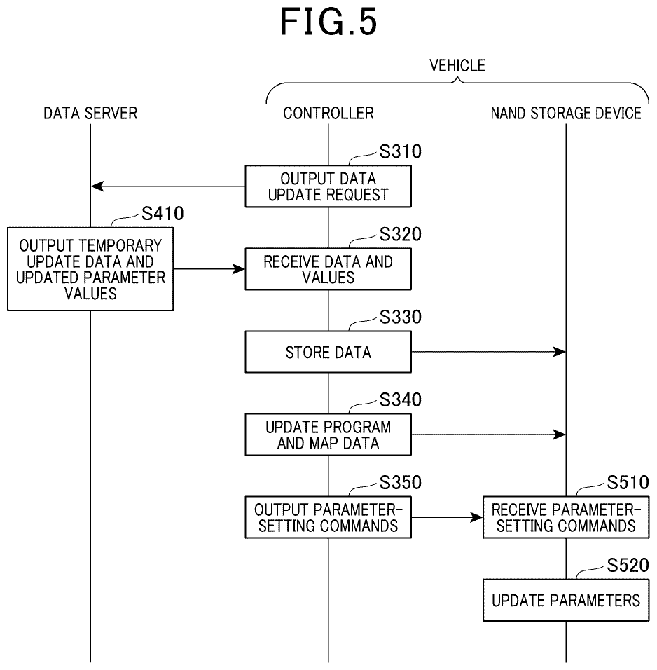

The processor 123 performs a refresh task, as demonstrated in FIG. 4, at regular intervals. Upon initiation of the refresh task in the processor 123, the routine proceeds to step S210 wherein the refresh request list is checked to look up the identification numbers. The routine then proceeds to step S220 wherein the blocks in the NAND memory 11 whose identification numbers are recorded in the refresh request list are all refreshed for reducing a risk that data in the target blocks may disappear. The routine then terminates.

1 As apparent from the above discussion, the built-in controller 12 compares the bit error rate of each block within the first memory area R1 of the NAND memory 11 with the first refresh threshold Th1 to determine whether data in the first memory area R1 should be self-refreshed. Similarly, the built-in controller 12 compares the bit error rate of each block within the second memory area R2 of the NAND memory 11 with the second refresh threshold Th2 to determine whether data in the second memory area R2 should be self-refreshed.

In the above way, the refresh threshold value is set suitable for characteristics of data retained in each area of the NAND memory 11, thereby ensuring the efficiency in self-refresh of data in the NAND memory 11.

For instance, the above technique in the first embodiment may be used to determine the first refresh threshold Th1, as set for the first memory area R1 where there is data having a higher importance or need to avoid a risk of data lost in the NAND memory 11, to be lower than the second refresh threshold Th2, thereby causing the important data to be refreshed an increased number of times to minimize the risk of data lost from the NAND memory 11.

In a case where the vehicle is not used for a long time (e.g., one year), so that the NAND storage device 1 is not used for an extended period time, a time interval between the last refresh of the blocks in the first memory area R1 and when the NAND storage device 1 starts not to be used is made relatively short, thereby minimizing the risk of data lost from the NAND memory 11.

2 The built-in controller 12 reads the first range value Rr1 and the second range value Rr2 from the memory 121 and compares the bit error rate of each block in the first memory area R1 specified by the first range value Rr1 with the first refresh threshold Th1 to determine whether data in the first memory area R1 should be self-refreshed. The built-in controller 12 also compares a bit error rate of each block in the second memory area R2 specified by the second range value Rr2 with the second refresh threshold Th2 to determine whether data in the second memory area R2 should be self-refreshed.

### Second Embodiment

The second embodiment will be described below with reference to FIG. 5 which is different from the first embodiment in inclusion of update of the program D11 or the map data D21 retained in the NAND memory 11. Other arrangements are identical with those in the first embodiment, and explanation thereof in detail will be omitted here.

The arithmetic circuit 23 of the controller 2 in the second embodiment executes a program illustrated in FIG. 5. After entering the program, the routine proceeds to step S310 wherein the arithmetic circuit 23 wirelessly outputs a data update request to an external data server located outside the vehicle through the wireless external communication system. Upon reception of the data update request, the external data server transmits the temporary update data D22 and update parameter values to the controller 2 in step S410.

The temporary update data D22 is, like in the first embodiment, obtained using the wireless external communication system from the external server located outside the vehicle and used as data for update of the program D11 and the map data D21 (e.g., data on differences between before and after the program D11 and the map data D21 are updated).

The update parameter values are values of the first refresh threshold Th1, the second refresh threshold Th2, the first range value Rr1, and the second range value Rr2 which are updated after the temporary update data D22 is reflected on the operation of the control system. The update parameter values may be all identical with, partly different from, or all different from values of the first refresh threshold Th1, the second refresh threshold Th2, the first range value Rr1, and the second range value Rr2 which are currently stored in the NAND storage device 1.

The change in one(s) or all of the first refresh threshold Th1, the second refresh threshold Th2, the first range value Rr1, and the second range value Rr2 may arise from how to use data in the NAND memory 11 and/or the size of the data in the NAND memory 11. In such an event, a producer of the temporary update data D22 makes the update parameter values to change one(s) or all of the first refresh threshold Th1, the second refresh threshold Th2, the first range value Rr1, and the second range value Rr2 as a function of a mode of the change thereof. The producer then stores the temporary update data D22 and the update parameter values in the external data server.

For instance, when the use of the temporary update data D22 results in a partial change in the program D11, thereby leading to an increased number of times the map data D21 is read from the memory 11, the current value of the second refresh threshold Th2 may be lowered.

When the use of the temporary update data D22 results in a partial change in the program D11, thereby leading to an increased number of times the dynamic learning data D12 is read from the memory 11, the current value of the first refresh threshold Th1 may be lowered.

When the use of the temporary update data D22 results in an increase in size of the map data D21, the current values of the first range value Rr1 and the second range value Rr2 may be changed to decrease the size of the first memory area R1 and increase the size of the second memory area R2. Conversely, when the use of the temporary update data D22 results in a decrease in size of the map data D21, the current values of the first range value Rr1 and the second range value Rr2 may be changed to increase the size of the first memory area R1 and decrease the size of the second memory area R2.

The arithmetic circuit 23 receives the temporary update data D22 and the update parameter values transmitted in the above way in step S320. The routine proceeds to step S330 wherein the temporary update data D22 is retained in the second memory area R2 of the NAND memory 11. The update parameter values may be stored in the NAND memory 11 or the non-volatile storage of the memory 22.

Subsequently, when an update time, e.g., when an operating load on the arithmetic circuit 23 is low or the vehicle is at rest, or a given time is reached, the routine proceeds to step S340 wherein the program D11 and the map data D21 in the NAND memory 11 are updated according to contents of the temporary update data D22.

The routine proceeds to step S350 wherein parameter-setting commands, as indicated by the update parameter values, which include update or target values of the first refresh threshold Th1, the second refresh threshold Th2, the first range value Rr1, and the second range value Rr2 are outputted to the built-in controller 12 of the NAND storage device 1. The routine proceeds to step S510 wherein the processor 123 of the built-in controller 12 receives the parameter-setting commands using the I/O device 122.

The routine proceeds to step S520 wherein the processor 123 updates the values of the first refresh threshold Th1, the second refresh threshold Th2, the first range value Rr1, and the second range value Rr2 to agree with the target values expressed by the parameter-setting commands as needed.

In the above way, the update of the program D11 and the map data D21 and the resulting update of the values of the first refresh threshold Th1, the second refresh threshold Th2, the first range value Rr1, and the second range value Rr2 in the memory 121 are completed. Subsequently, the error correction task and the refresh task are performed using the updated values of the first refresh threshold Th1, the second refresh threshold Th2, the first range value Rr1, and the second range value Rr2.

1 As apparent from the above discussion, either or both of the first refresh threshold Th1 and the second refresh threshold Th2 are capable of being altered or updated according to commands outputted from the controller 2. This enables the first refresh threshold Th1 and/or the second refresh threshold Th2 to be set depending on required conditions. The same is true for the first range value Rr1 and/or the second range value Rr2.
2 The above update is achieved in response to the update of the program D11 or the map data D21. This enables the first refresh threshold Th1 and the second refresh threshold Th2 to be changed or updated according to updated contents of the program D11 or the map data D21. The same is true for the first range value Rr1 or the second range value Rr2.

The same arrangements or operations in the second embodiment as those in the first embodiment offer substantially the same beneficial advantages.

### Third Embodiment

The third embodiment will be described below which is different from the first or second embodiment in defining a relation of the size of each of the program D11, the dynamic learning data D12, the map data D21, and the temporary update data D22 with the capacity of each of the first memory area R1 and the second memory area R2. The data size, as referred to herein, is a size of data at the logical address. The capacity, as referred to herein, is a capacity defined by the physical address in the NAND memory 11.

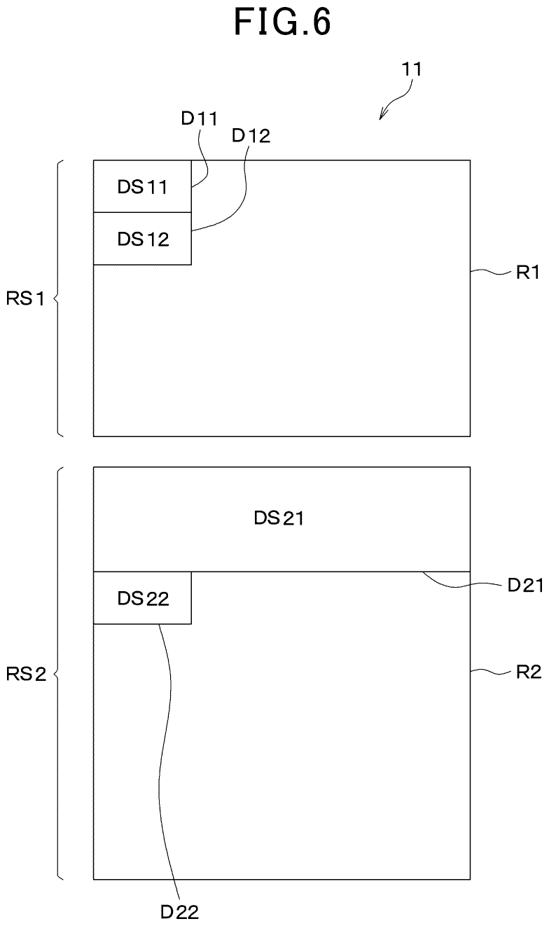

In this embodiment illustrated in FIG. 6, the program D11 has the data size DS11. The dynamic learning data D12 has the data side DS12. The map data D21 has the data size DS21. The temporary update data D22 has the data size DS22. The first memory area R1 has the capacity RS1. The second memory area R2 has the capacity RS2. These data sizes and capacities are selected to meet a relation of RS1/(DS11+DS12)>RS2/(DS21+DS22).

In other words, a ratio of the capacity of the first memory area R1 to the size of data stored in the first memory area R1 is greater than a ratio of the capacity of the second memory area R2 to the size of data stored in the second memory area R2.

When the first refresh threshold Th1 is smaller than the second refresh threshold Th2, it will result in an increased number of times the first memory area R1 is refreshed. The wear of the whole of the first memory area R1 is, however, decreased by setting the ratio of the capacity of the first memory area R1 to the size of data stored in the first memory area R1.

The relations of (DS11+DS12)< (DS21+DS22) and RS1<RS2 are met regardless of the above area-to-capacity ratio because the size of the map data D21 is much greater than other data sizes. The satisfaction of RS1<RS2 enables an increase in overall capacity of the NAND memory 11 to be suppressed even though the ratio of RS1 to (DS11+DS12) is to be large.

The same arrangements or operations of the third embodiment as those of the first or second embodiment offer substantially the same beneficial advantages.

### OTHER EMBODIMENTS

This disclosure is not limited to the above embodiments, however, may be realized by various embodiments without departing from the purpose of the disclosure. This disclosure includes all possible combinations of the features of the above embodiments or features similar to the parts of the above embodiments. The structures in this disclosure may include only one or some of the features discussed in the above embodiments unless otherwise inconsistent with the aspects of this disclosure. The component parts described in the above embodiments are not necessarily essential unless otherwise specified or viewed to be essential in principle. When the number of the component parts, a numerical number, a volume, or a range is referred to in the above discussion, this disclosure is not limited to it unless otherwise specified or viewed to be essential in principle. In one of the above embodiments wherein an external environmental condition (e.g., the degree of humidity) outside the vehicle are derived using a sensor(s), the external environmental condition may alternatively be obtained from a server or a cloud arranged outside the vehicle instead of the sensor(s). Alternatively, information associated with the external environmental condition may be obtained from the server or the cloud and analyzed to calculate the external environmental condition. Particularly, in a case where a plurality of values are exemplified as expressing a given physical quantity in the above embodiments, the physical quantity may be represented by a value calculated to be intermediate between the above values unless otherwise specified or inconsistent with the aspects of this disclosure. When the shape of, the orientation of, or the positional relation among component parts in the above embodiments is referred to in the above discussion, this disclosure is not limited to it unless otherwise specified or clearly essential in principle. Discrete modifications or a combination(s) of the modifications, as discussed below, may be selectively used with one or some of the above embodiments.

The arithmetic circuit 23 or the processor 123 or how to construct them or perform the operations thereof referred to in this disclosure may be realized by a special purpose computer which is equipped with a processor and a memory and programmed to execute one or a plurality of tasks created by computer-executed programs or alternatively established by a special purpose computer equipped with a processor made of one or a plurality of hardware logical circuits. The controllers or operations thereof referred to in this disclosure may alternatively be realized by a combination of an assembly of a processor with a memory which is programmed to perform one or a plurality of tasks and a processor made of one or a plurality of hardware logical circuits. Computer-executed programs may be stored as computer executed instructions in a non-transitory computer readable medium.

### First Modification

The NAND memory 11 referred to in the above embodiment has a storage or memory area including the first memory area R1 and the second memory area R2 to which refreshing threshold values (i.e., the first refresh threshold Th1 and the second refresh threshold Th2) different from each other are provided, but however, the NAND memory 11 may alternatively be designed additionally to include a third area to which a third refresh threshold is provided. Similarly, the memory area of the NAND memory 11 may also include a fourth or more area to which a given refresh threshold(s) is assigned.

### Second Modification

The above embodiments have referred to a bit error rate in each block of the first memory area R1, but however, they are not limited to it. The same is true for the second memory area R2.

### Third Modification

The above embodiments have referred to the controller 2 for use in driver-assistance system for the vehicle, but however, the controller 2 arranged outside the NAND storage device 1 in the form of an external device may alternatively be designed as a processor to perform, for example, a route navigation task. The controller 2 and/or the NAND storage device 1 may be implemented by a domain controller arranged outside the vehicle.

### Unique Aspects Offered by this Disclosure First Aspect

A NAND storage device is provided which comprises: (a) a NAND memory (11) which is installed in the NAND storage device and includes a first memory area (R1) and a second memory area (R2); and (b) a built-in controller (12) which is installed in the NAND storage device and works to write or read data in or from the NAND memory in response to a command outputted from an external device (2). The built-in controller obtains a first refresh threshold (Th1) and a second refresh threshold (Th2). The built-in controller works to compare a bit error rate in the first memory area of the NAND memory with the first refresh threshold to determine whether data in the first memory area should be self-refreshed and also compare a bit error rate in the second memory area of the NAND memory with the second refresh threshold to determine whether data in the second memory area should be self-refreshed.

### Second Aspect

The NAND storage device as set forth in “FIRST ASPECT”, wherein at least one of the first refresh threshold and the second refresh threshold is capable of being altered in response to a command outputted from the external device.

### Third Aspect

The NAND storage device as set forth in “FIRST ASPECT” or “SECOND ASPECT”, wherein the NAND memory stores therein a program to be executed by the external device or a map data used in the external device. A least one of the first refresh threshold and the second refresh threshold is capable of being altered in response to a command from the external device when the program or the map data is updated.

### Fourth Aspect

The NAND storage device as set forth in any one of “FIRST ASPECT” to “THIRD ASPECT”, wherein the built-in controller works to obtain a first range value (Rr1) and a second range value (Rr2) in addition to the first refresh threshold and the second refresh threshold. The first range value defines a range occupied by the first memory area in the NAND memory. The second range value defines a range occupied by the second memory area in the NAND memory. The built-in controller compares the bit error rate in the first memory area specified by the first range value with the first refresh threshold to determine whether the data in the first memory area is required to be self-refreshed and also compares the bit error rate in the second memory area specified by the second range value with the second refresh threshold to determine whether the data in the second memory area is required to be self-refreshed.

### Fifth Aspect

The NAND storage device as set forth in “FOURTH ASPECT”, wherein at least one of the first range value and the second range value is capable of being altered in response to a command outputted from the external device.

### Sixth Aspect

The NAND storage device as set forth in “FOURTH SPECT” or “FIFTH ASPECT”, wherein the NAND memory stores therein a program to be executed by the external device or a map data used in the external device. At least one of the first range value and the second range value is capable of being altered in response to a command outputted from the external device when the program or the map data is updated.

### Seventh Aspect

The NAND storage device as set forth in “FIRST ASPECT” or “FOURTH ASPECT”, wherein the first memory area stores therein a program to be executed by the external device. The second memory area stores therein a map data used by the external device when executing the program. The second refresh threshold is greater in value than first refresh threshold.

### Eighth Aspect

The NAND storage device as set forth in “SEVENTH ASPECT”, wherein the second memory area stores therein a temporary update data for update of the program or the map data.

### Ninth Aspect

The NAND storage device as set forth in “SEVENTH ASPECT” or “EIGHTH ASPECT”, wherein the first memory area stores therein a dynamic learning data which is looked-up or altered when the external device executes the program.

### Tenth Aspect

The NAND storage device as set forth in any one of “FIRST ASPECT” to “NINTH ASPECT”, wherein the data retained in the second memory area has a size greater than that of the data retained in the first memory area. The second refresh threshold is greater than the first refresh threshold. A ratio of a capacity of the first memory area to the size of the data in the first memory area is greater than a ratio of a capacity of the second memory area to the size of the data in the second memory area.

### Eleventh Aspect

The NAND storage device as set forth in any one of “FIRST ASPECT” to “NINTH ASPECT”, wherein the NAND storage device is installed in a vehicle.

What is claimed is:

1. A NAND storage device comprising:
a NAND memory which is installed in the NAND storage device and includes a first memory area and a second memory area; and
a built-in controller which is installed in the NAND storage device and works to write or read data in or from the NAND memory in response to a command outputted from an external device, wherein
the built-in controller obtains a first refresh threshold and a second refresh threshold, the built-in controller working to compare a bit error rate in the first memory area of the NAND memory with the first refresh threshold to determine whether it is required to self-refresh data in the first memory area and also compare a bit error rate in the second memory area of the NAND memory with the second refresh threshold to determine whether it is required to self-refresh data in the second memory area.

2. The NAND storage device as set forth in claim 1, wherein at least one of the first refresh threshold and the second refresh threshold is capable of being modified in response to a command outputted from the external device.

3. The NAND storage device as set forth in claim 1, wherein the NAND memory stores therein a program to be executed by the external device or a map data used in the external device,
at least one of the first refresh threshold and the second refresh threshold is capable of being altered in response to a command from the external device when the program or the map data is updated.

4. The NAND storage device as set forth in claim 1, wherein the built-in controller works to obtain a first range value and a second range value in addition to the first refresh threshold and the second refresh threshold, the first range value defining a range occupied by the first memory area in the NAND memory, the second range value defining a range occupied by the second memory area in the NAND memory,
the built-in controller compares the bit error rate in the first memory area specified by the first range value with the first refresh threshold to determine whether the data in the first memory area is required to be self-refreshed and also compares the bit error rate in the second memory area specified by the second range value with the second refresh threshold to determine whether the data in the second memory area is required to be self-refreshed.

5. The NAND storage device as set forth in claim 4, wherein at least one of the first range value and the second range value is capable of being altered in response to a command outputted from the external device.

6. The NAND storage device as set forth in claim 4, wherein the NAND memory stores therein a program to be executed by the external device or a map data used in the external device,
at least one of the first range value and the second range value is capable of being altered in response to a command outputted from the external device when the program or the map data is updated.

7. The NAND storage device as set forth in claim 1, wherein the first memory area stores therein a program to be executed by the external device,
the second memory area stores therein a map data used by the external device when executing the program,
the second refresh threshold is greater than first refresh threshold.

8. The NAND storage device as set forth in claim 7, wherein the second memory area stores therein a temporary update data for update of the program or the map data.

9. The NAND storage device as set forth in claim 7, wherein the first memory area stores therein dynamic learning data which is read or modified when the external device executes the program.

10. The NAND storage device as set forth in claim 1, wherein the data retained in the second memory area has a size greater than that of the data retained in the first memory area,
the second refresh threshold is greater than the first refresh threshold, and
a ratio of a capacity of the first memory area to the size of the data in the first memory area is greater than a ratio of a capacity of the second memory area to the size of the data in the second memory area.

11. The NAND storage device as set forth in claim 1, wherein the NAND storage device is installed in a vehicle.
